(19) United States
(12) Patent Application Publication
(10) Pub. No.: US 2015/0161329 A1
(43) Pub. Date: Jun. 11, 2015

(54) SYSTEM AND METHOD FOR MATCHING PATIENT INFORMATION TO CLINICAL CRITERIA

(71) Applicant: KONINKLIJKE PHILIPS N.V., EINDHOVEN (NL)

(72) Inventors: Thusitha Dananjaya De Silva Mabotuwana, Yonkers, NY (US); Michael Chun-chieh Lee, Lexington, MA (US); Eric Cohen-Solal, Ossining, NY (US)

(21) Appl. No.: 14/404,048

(22) PCT Filed: May 28, 2013
(86) PCT No.: PCT/IB2013/054393

§ 371 Date: Nov. 26, 2014

Related U.S. Application Data
(60) Provisional application No. 61/654,185, filed on Jun. 1, 2012.

(51) Int. Cl. G06F 19/00

(52) U.S. Cl. CPC G06F 19/322

(57) ABSTRACT

The exemplary embodiments are related to systems and methods for automatically selecting one or more suitable medical imaging protocols based on a patient's clinical information. Exemplary embodiments relate to methods and systems for collecting clinical information for a current patient, generating an encoded description of a plurality of imaging protocols in a computer-processable format including medical concepts, converting the collected clinical information into the computer-processable format, and recommending or providing at least one suitable imaging protocol based on the encoded description and the converted clinical information for the current patient.

### FIELD OF THE INVENTION

In the field of health care, medical imaging is the technique of creating images of a patient, such as body parts and their corresponding functionalities, for both clinical purposes and medical purposes. For instance, clinical applications of medical imaging may implement medical procedures for revealing, diagnosing and/or examining diseases. Medical applications of imaging techniques may be used to study the anatomy and physiology of the patient.

### BACKGROUND OF THE INVENTION

The various forms of medical imaging processes include, but are not limited to, computed tomography (“CT”), magnetic resonance imaging (“MRI”), positron emission tomography (“PET”), ultrasound, etc. The imaging process of CT scanning produces a volume of data that can be manipulated, through a process known as “windowing”, in order to demonstrate various bodily structures based on their ability to block an X-ray beam. The process of MRI scanning is used to visualize detailed internal structures through the use of nuclear magnetic resonance to image nuclei of atoms inside the body. Unlike CT scans or traditional X-rays, MRI does not use ionizing radiation. The process of PET imaging produces a three-dimensional image of a functional process in the body through the detection of gamma rays emitted by a positron-emitting radionuclide (e.g., a tracer). The process of ultrasound imaging is used for visualizing subcutaneous body structures such as tendons, muscles, joints, vessels and internal organs for possible pathology or lesions.

A medical imaging order from a referring physician is received by a radiology department or imaging center of a medical institution. The order typically describes the general type of examination performed (e.g., CT, MRI, PET, ultrasound, etc.), as well as the anatomy scanned. Additionally, the order will contain “clinical indications” from the referring physician to indicate the reason for the imaging order. These indications are typed in free hand, as opposed to coded terms form standardized clinical terminology. The indication may include symptoms, clinical history and hypotheses of the underlying disease or condition of the patient. Furthermore, the indications may include conditions that need to be “ruled-out” as well as suggesting potential conditions that should be investigated in particular.

A radiologist reviews the imaging order and assigns a clinical imaging protocol among a list of pre-defined protocols. Accordingly, each protocol is defined by a set of clinical indications for which this protocol is used and describes the scanner settings to be used during image acquisition. In its simplest form, this set of indications can be a list of clinical findings, diseases, or symptoms. If a patient has one or more of these clinical conditions, then he or she should be imaged using the specified protocol. More complex criteria can also be established including the combination of multiple clinical findings with various logical operators.

The process of selecting the right protocol for a given patient based on relevant clinical indications can be referred to as “protocoling.” Other information can also be reviewed during the selection process, such as laboratory data, prior radiology reports, other clinical reports, etc. Due to the lack of unified protocols accepted across all imaging institutes, these protocols are usually institution-specific. This process of selecting a protocol occurs before the patient is scanned, typically hours to days before the patient arrives for his or her imaging examination.

Currently, there exist information technology solutions to aid in the protocoling process. However, these are focused on digitizing and displaying what has previously been a paper-based process. Conventional processes electronically collect the imaging order along with other clinical information about the patient and provide a digital list of all clinical scan protocols from which to choose. However, these processes do not provide any assistance in choosing one of those protocols. Furthermore, the conventional processes lack any standardization. As noted above, the clinical indications in the imaging order are typically entered as free-text information by many different referring physicians, wherein diverse writing style and medical wording will vary greatly. This diversity needs to be managed through an adequate information extraction stage, knowledge representation and semantic reasoning stage to allow for the recommendation of one or more adequate protocols. Thus, comparison between the clinical indication in the imaging order and the clinical criteria established in the protocols may be non-trivial for a computer or a trained human expert.

### SUMMARY OF THE INVENTION

The aforementioned problems are overcome by the exemplary embodiments described herein. As a result, automatic selection of imaging protocols will minimize errors and inconsistencies that occur when selection of medical imaging protocols is performed manually using the current processes. By providing information to support the choice of the recommended protocol, the exemplary embodiments improve confidence in decision making, while also having a learning effect for novice or less experienced radiologists. Moreover, the exemplary embodiments reduce the amount of time required by the person who performs the protocol assignment (e.g. a radiologist, a physician, or any other clinical person) to perform this protocoling task. This time consideration is particularly important as the amount of input data (e.g., patient information) increases with the growth of electronic records.

The exemplary embodiments are related to systems and methods for automatically selecting one or more suitable medical imaging protocols based on a patient's clinical information. One embodiment relates to a method comprising collecting clinical information for a current patient, generating an encoded description of a plurality of imaging protocols in a computer-processable format including medical concepts, converting the collected clinical information into the computer-processable format, and recommending or providing at least one suitable imaging protocol based on the encoded description and the converted clinical information for the current patient.

A further embodiment relates to a system comprising:
a data collection subsystem for collecting clinical information for a current patient,
an imaging protocol subsystem for generating an encoded description of a plurality of imaging protocols in a computer-processable format including medical concepts,
a natural language processor for converting the collected clinical information into the computer-processable format, and a protocol recommendation subsystem for recommending or providing at least one suitable imaging protocol based on the encoded description and the converted clinical information for the current patient.

A further embodiment relates to a non-transitory computer readable storage medium including a set of instructions that are executable by a processor, the set of instructions being operable at least to collect clinical information for a current patient, generate an encoded description of a plurality of imaging protocols in a computer-processable format including medical concepts, convert the collected clinical information into the computer-processable format, and recommend or provide at least one suitable imagining protocol based on the encoded description and the converted clinical information for the current patient.

### BRIEF DESCRIPTION OF THE DRAWINGS

FIG. 1 shows an exemplary system for automatically selecting one or more suitable medical imaging protocols based on a patient's clinical information according to an exemplary embodiment described herein.

FIG. 2 shows an exemplary method for automatically selecting one or more suitable medical imaging protocols based on a patient's clinical information according to an exemplary embodiment described herein.

FIG. 3 shows an exemplary table of a plurality of categories of cases for natural language processing (“NLP”) matching based on concepts found by an NLP engine according to an exemplary embodiment described herein.

### DETAILED DESCRIPTION OF THE EMBODIMENTS

The exemplary embodiments may be further understood with reference to the following description of exemplary embodiments and the related appended drawings, wherein like elements are provided with the same reference numerals. The exemplary embodiments are related to systems and methods for automatically selecting one or more suitable medical imaging protocols, or imaging procedures, based on clinical information about the patient (e.g., a patient profile). For instance, the exemplary systems and methods can be used for analyzing an imaging order from a referring physician and the clinical information of the patient in the context of pre-established clinical criteria and automatically suggesting one or more correct protocols to be used in imaging the patient.

As will be described in greater detail below, these exemplary systems and methods use algorithms (e.g., software applications) to retrieve and process clinical information about patients and the clinical criteria for the protocols. These embodiments provide a recommendation of one or more imaging protocols from a list of institution-specific imaging protocols. This recommendation is based upon information extracted from the patient clinical record, including but not limited to clinical indications, laboratory data, prior imaging reports and other reports from clinical examinations. Accordingly, a user (e.g., radiologist) will use these systems and methods to read the information about the patient and then select a scan protocol for the patient with the assistance of the recommendation engine. Specifically, medical information is analyzed in the context of the computer-interpretable clinical criteria for each protocol to lead to a decision on one or more recommendations. Thus, the exemplary embodiments will reduce errors and inconsistencies that typically occur when medical imaging protocols are manually selected by radiologists, while also reducing the amount of time required to perform this task.

It should be noted that while the embodiments discussed herein relate to recommending medical imaging protocols, one skilled in the art would understand that these exemplary systems and methods can be used in all fields of health care and cover a variety of medical examination procedures. Furthermore, the exemplary recommendation systems and methods described herein can serve as a clinical decision component in any number of medical reporting software suites. The systems and methods can also be integrated as a whole or in part into imaging modality consoles and/or workspaces, such as consoles for MR, CT, NM, ultrasound, etc.

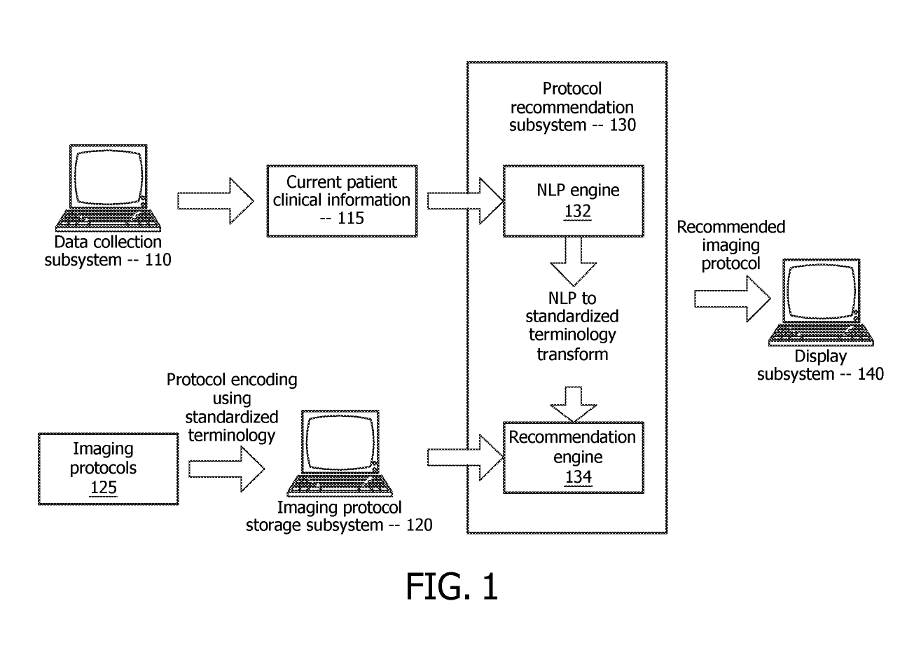

FIG. 1 shows an exemplary system 100 for automatically selecting one or more suitable medical imaging protocols based on a patient's clinical information according to an exemplary embodiment described herein. Specifically, the exemplary architecture of the system 100 includes a data collection subsystem 110, an imaging protocol storage subsystem 120, a protocol recommendation subsystem 130 and a display subsystem 140. It should be noted that while each of these subsystems 110-140 are displayed as separate components, any number of these subsystems may be integrated into one or more other subsystems.

The data collection subsystem 110 collects clinical information 115 about the patient, including at least clinical indication(s). In addition, the collected clinical information can optionally include laboratory data, prior imaging reports, and other reports from clinical examinations. Specifically, the data collection subsystem 110 for collecting clinical information 115 about the patient utilizes well-known methods from healthcare information technology. The order information, laboratory information, prior imaging reports and other reports can be transmitted and stored via health information technology standards, such as, but not limited to Health Level Seven International (“HL7”), Digital Imaging and Communications in Medicine (“DICOM”), etc. The data collection subsystem 110 can include a database for storing the collected clinical information 115. The storing can be executed automatically or when selected by the physician user. Alternatively or additionally, information retrieved by any of the subsystems 110-140 can be stored in a general system-wide database.

The imaging protocol storage subsystem 120 collects and stores a list of institution-specific medical imaging protocols 125, also known as clinical scan protocols, as well as the associated clinical criteria for use of these protocols. Once the protocols 125 are collected, the clinical criteria for using these protocols (e.g., clinical indications) are encoded using medical concepts, which are part of an ontology, such as the Systematized Nomenclature of Medicine (“SNOMED”). Each of the protocols 125 is consequently described using well-controlled, standardized terminology with an ontological representation. Each of the plurality of clinical criteria for each protocol 125 is be composed of individual concepts or a combination of concepts as defined using logical operators. The collection and storage of the imaging protocols 125 is performed off-line and remains valid until the institution decides to update their protocols.

According to one embodiment of the system 100, the collection and storage of protocols 125 includes encoding of the clinical criteria in the Web Ontology Language—eXtensible Markup Language (“OWL/XML”) format using SNOMED concept identifiers combined using description logic. For instance, the criteria can be encoded as a “necessary and sufficient condition,” wherein a logical statement that fully defines the members of this set.

The protocol recommendation subsystem 130 includes an NLP engine 132 and a recommendation engine 134. The NLP engine 132 analyzes the clinical information 115 in order to standardize the natural language terminology contained in the patient clinical information 115. In other words, the free-text clinical information for the patient received from the user physician is converted into a format comparable to that of the structured and encoded protocol criteria. This encoding is automatically performed through the use of NLP algorithms. The result is a description of the patient containing codes conforming to a selected medical terminology, such as SNOMED, Unified Medical Language System (“UMLS”), etc. The NLP engine 132 and related examples will be further described below.

The recommendation engine 134 presents one or more clinical scan protocols 125 based on their appropriateness for the individual patient given the clinical criteria associated with those protocols 125. This recommendation engine 134 is used to recommend a selection as to which medical imaging protocols should be used. According to exemplary embodiments of the system 100, the recommendation engine 134 can be executed either automatically, or upon request by the physician user. The input to the recommendation engine 134 includes the encoded description of the protocol criteria, as well as the processed patient history from the NLP engine 132. As noted above, the patient history is processed so that the patient description conforms to the same format and syntax and description used to describe the protocol criteria. Through additional internal algorithms, the result provided by the recommendation engine 134 is one or more of suitable imaging protocols.

Finally, the display subsystem 140 suitably presents, e.g displays the input clinical information 115 and the resulting imaging recommendation. Specifically, the input information from the data collection subsystem 110 and resulting protocols are presented to the physician user via a computer screen. The presentation of the suggested procedure(s) is be communicated to the user by presenting the possible procedures e.g. as a sorted list, a filtered list, or an unsorted list, with or without the reasoning behind each protocol recommendation. While displaying information to the physician user, the display subsystem 140 can allow the physician user to accept or modify/reject the suggested protocol.

Furthermore, enhancements of the exemplary system 100 relate to the display of the results, particularly with regard to explaining the computer-generated suggestions, and transmission of the results to a selected imaging scanner. According to one enhancement, the clinical terms describing the patient situation that were detected and used in the NLP and reasoning steps can be highlighted visually on the screen for display to the user. According to an additional enhancement, the selected protocol can be transmitted to the image scanner. The protocol comprises the scanner settings which—according to said selected protocol—are to be used during image acquisition. These selected scanner settings can be transmitted by a protocol transmission subsystem to the imaging scanner and can be used to control the scanning operation of the imaging scanner. This way, not only errors and inconsistencies in selection of the imaging protocol are minimized, but also errors that occur when scanner settings of a given imaging protocol are manually entered to or selected at an imaging scanner. In this enhancement, a display subsystem 140 which allows the user to accept or modify/reject the suggested protocol can be implemented in part or as a whole as a subsystem of the imaging scanner. The transmission operation can be performed using standard methods, such as by encoding the protocol as a Radiology Information Systems (“RIS”) Procedure ID and transmitting via the DICOM modality worklist.

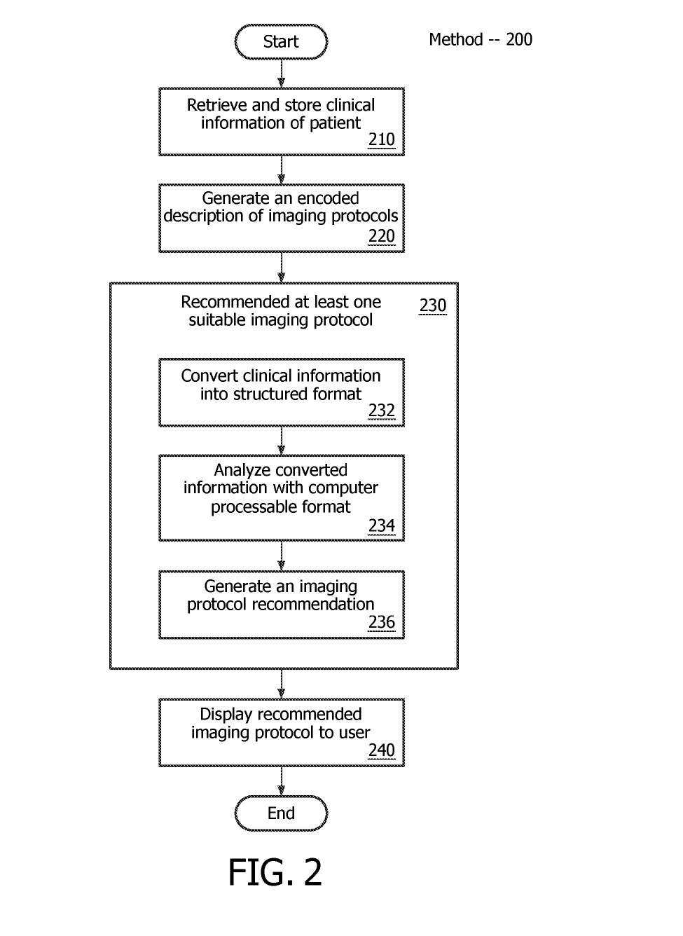

FIG. 2 shows an exemplary method 200 for automatically selecting one or more suitable medical imaging protocols based on a patient's clinical information according to an exemplary embodiment described herein. It should be noted that method 200 will be discussed with reference to system 100 and related subsystems 110-140 illustrated in FIG. 1. The collection of data and the subsequent recommendations are performed by one or more processors of the system 100, such as the NLP engine 132 and the recommendation engine 134. As indicated above, any one of or all of the steps performed throughout the exemplary system 100 can be executed automatically or when selected by the user.

Beginning with step 210, the data collection subsystem 110 of the system 100 receives and stores clinical information about the current patient.

In step 220, the imaging protocol storage subsystem 120 of the system 100 receives and stores a list of institution-specific medical imaging protocols 125. As noted above, imaging protocol storage subsystem 120 stores an encoded description of a plurality of imaging protocols in a computer-processable format including medical concepts. It should be noted that while steps 210 and 220 appear sequential in method 200, these two steps can be performed at the same. In other words, the exemplary method 200 is not limited to the sequence depicted in FIG. 2. Additional steps may be added or omitted, and certain steps may be performed serially or in parallel to other steps.

In step 230, the protocol recommendation subsystem 130 recommends at least one suitable imagining protocol. The step 230 is separated into three sub-steps. In sub-step 232, the NLP engine 132 of the protocol recommendation subsystem 130 converts free-text of the clinical information provided by the physician user into a structured format such as SNOMED, Unified Medical Language System (“UMLS”), etc. The converting of the collected clinical information into the computer-processable format includes using at least one natural language processing (“NLP”) algorithm of the NLP engine 134. In sub-step 234, the recommendation engine 134 of the protocol recommendation subsystem 130 receives the encoded protocol criteria from the imaging protocol storage subsystem 120. In sub-step 234, the converted clinical information is analyzed in the context of the computer processable format. Further details and examples of the step 230 and its sub-steps 232-236 will be described below.

In sub-step 236, the protocol recommendation subsystem 130 generates an imaging protocol recommendation based on the encoded description of the protocol data from the sub-step 234 and the processed patient history data from the sub-step 232.

In step 240, the display subsystem 140 displays one or more recommended imaging protocols to the user over a display (e.g., computer monitor, console or workspace display, etc.). Furthermore, upon displaying the one or more recommended imaging protocols to the user, the display subsystem 140 receives an input instruction from the user. This input instruction allows the user to accept, reject or modify the imaging protocols recommended by the protocol recommendation subsystem 130.

Thus, the exemplary method 200 and system 100 provide users (e.g., physicians, clinicians, hospital personnel, etc.) with decision support through recommending one or more suitable medical imaging protocols based on current clinical information about a patient. According to one of the exemplary embodiments, the system 100 is an add-on component to existing hospital and radiology informatics systems, such as picture archiving and communication systems (“PACS”) or radiology information systems (“RIS”).

As an example, an exemplary computed tomography imaging protocol may have the clinical criteria of “gastrointestinal hemorrhage.” As per step 220, this patient information may be encoded in one or more logical expressions with reference to the SNOMED code: 74474003. When the patient imaging order contains the sentence, “patient presents with gastrointestinal bleeding,” the NLP engine 132 produces a medical concept directly corresponding to this description (i.e., “SNOMED: 74474003”). In such a case, if one protocol contains the clinical indication coded as “gastrointestinal hemorrhage”, there is a direct match between the current patient information and the corresponding protocol. Thus, this corresponding protocol will be recommended in the subsequent step 236 of the method 200.

In a further example, the NLP engine 132 produces coded descriptions of the patient indications that are not well-matched with the encoded protocol criteria. If the patient imaging order contains the description “patient presents with bleeding located in the GI region”, the NLP algorithm might produce a different result, such as, in the form of two identified medical concepts (or codes): “hemorrhage” (e.g., SNOMED: 50960005) and “gastrointestinal tract structure” (e.g., SNOMED: 122865005). In this case, the two codes produced were more fragmented leading to more difficulty to automatically match this patient to the adequate protocol (e.g., with clinical indication coded “gastrointestinal hemorrhage”).

The issue illustrated in this second example can be solved by a second stage of post-processing of the results from the NLP engine 132 to combine the possibly fragmented results into one or more concepts that conform to medical concepts described in the clinical criteria for the protocols defined in step 220. That is, in the previous example, from the “hemorrhage” and “gastrointestinal tract structure” results, the recommendation engine 134 logically infers “gastrointestinal hemorrhage.”

Exemplary approaches to overcoming the above-illustrated issue are given in the following two exemplary embodiments. In a first embodiment, the exemplary system 100 and method 200 use the ontological representation (e.g. SNOMED) to make a novel inference. In many ontologies, the concepts are defined by necessary and sufficient conditions, as referenced above in step 220. These conditions fully define a concept as a set of individuals fulfilling certain logical criteria. This may be referred to as the “definition” of a “composite” ontology concept.

Within the scope of this embodiment, seven distinct categories of NLP related issues have been identified. However, it should be noted that other categories are possible and these additional categories may be resolved in a manner consistent with the below description of the seven exemplary categories. In these exemplary categories, the NLP algorithm produces inexact codes, or “fragments,” which would not directly match the codes of any protocol's clinical indications.

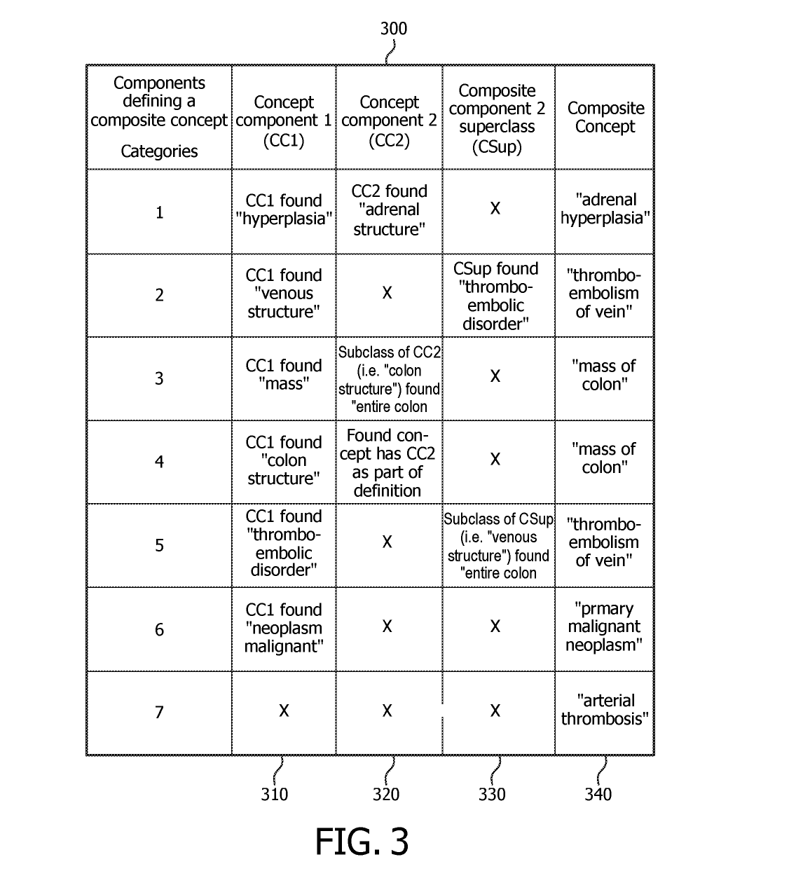

FIG. 3 shows an exemplary table 300 of a plurality of categories of cases for natural language processing (“NLP”) matching based on concepts found by the NLP engine 132 according to an exemplary embodiment described herein. Specifically, the table 300 summarizes these seven distinct categories of NLP related issues. For each row, the cells for columns 310, 320 and 330 contain an example of concepts found by the NLP engine 132. Column 340 contains the exact concept that is required. Below is a listing for each of the categories of cases:

Category 1—The NLP engine 132 finds the different components in the definition of the ontology term not including the direct superclass. An example is the exact code for the composite concept “adrenal hyperplasia” (column 340) that is defined in the ontology as the logical equivalent of code “hyperplasia” (CC1 of column 310) and code “adrenal structure” (CC2 of column 320). The NLP engine 132 finds these two terms, CC1 and CC2, but not the exact one. However, the exemplary embodiment will identify the composite concept “adrenal hyperplasia” based on the CC1 and CC2 terms.

Category 2—The NLP engine 132 finds one component in the logical definition of the ontology term and the direct superclass. An example is the composite concept code “thromboembolism of vein” (column 340) that has the code “venous structure” (CC1 of column 310) in its definition and is a subclass of “thromboembolic disorder” (CSup of column 330). The NLP engine 132 finds these two terms, not the third one “Thromboembolus (Defining),” i.e., there was no CC2 identified by the NLP engine 132 that could be used to define the composite concept using CC1 and CC2 as described above for Category 1. However, in this example, the CC1 and the CSup are used to identify the composite concept.

Category 3—The NLP engine 132 finds one component of the logical definition and a subclass of the other component of the definition of an ontology term, excluding the direct superclass. An example is the composite concept code “mass of colon” (column 340) that is logically equivalent to code “mass” (CC1 column 310) and code “colon structure” (CC2 column 320). However, an exemplary NLP result in this case finds code “mass” and code “entire colon,” wherein entire colon is a sub-concept, or subclass, of the colon structure. Thus, in this example, the NLP engine 132 did not find the exact match for the CC2 to generate the composite concept, but was still able to generate the composite concept based on the subclass of the CC2 and the direct match of CC1.

Category 4—The NLP engine 132 finds one component of the logical definition and a term that is in the definition of a definition term including the direct superclass. An example is the composite concept code “mass of colon” (column 340) that is logically equivalent to code “mass” and “colon structure”. However, an exemplary NLP result in this case finds code “colon structure” (CC 1 column 310) and code “mass of body structure” (CC2 column 320 signified by the words “found concept has CC2 as part of its definition”) wherein mass of body structure has mass as part of its definition. Thus, the exemplary embodiment is able to identify the composite concept “mass of colon” from the direct match of CC1 and the definition of CC2.

Category 5—This is similar to category 3 listed above, but in this case The NLP engine 132 finds a subclass of the other component of the definition of an ontology term including the direct superclass. An example is the composite concept “thromboembolism of vein” (column 340) that has “thromboembolic disorder” and “venous structure” in its signature including direct superclass. In this case, the NLP engine 132 finds “thromboembolic disorder” (CC1 column 310) and “entire vein” (CSup 330) wherein entire vein is a subclass of the venous structure.

Category 6—This category looks at composite concepts with only two components in its definition and matches the NLP engine 132 to one of the components. An example is the composite concept “primary malignant neoplasm” (Column 340), given NLP findings “principal” and “neoplasm, malignant (primary).” Only concepts with two components are included to minimize the number of false positives.

Category 7—This category is based on string matching using Similarity Score algorithms that determine how similar two strings (e.g., ordered set of alphabet characters) are. For two given NLP results, the NLP engine 132 determines the similarity scores between a composite concept description (“Preferred term”) and each NLP result. Both scores are required to be greater than or equal to 4 and at least one result should have a score greater than or equal to 5. An example is finding the composite concept “Arterial thrombosis” (column 340), given the NLP results “Thromboembolic disorder” and “Arterial,” wherein “Arterial thrombosis” does not have “Thromboembolic disorder” or “Arterial” in its definition to be captured by any of the first six categories. The specific string-matching algorithm used here is the Longest Common Substring algorithm. It should be noted that other standard matching algorithms, such as Levenshtein distance, Hamming distance, etc., may also be used or used as an alternative. In the given example, the Similarity Score for “Arterial thrombosis” and “Thromboembolic disorder” is 7, while similarity between “Arterial thrombosis” and “Arterial” is 8.

Accordingly, the NLP results are matched to the above categories in order (i.e., if a given NLP result satisfies category 1, subsequent categories are ignored). The NLP result post-processing module takes these fragments of codes to search the ontology for medical concepts related to these fragments. As a result, this post-processing module generates multiple candidates. For instance, for “hemorrhage” and “gastrointestinal tract structure,” the multiple concepts that satisfy the logical constraints are: “Lower gastrointestinal hemorrhage,” “Gastrointestinal hemorrhage” and “Acute gastrointestinal hemorrhage.” In order to minimize the number of such candidates, two filtering techniques can be used.

A first filtering technique is used to determine whether there is a hierarchical relationship between the candidates. If so, all except the most general term are filtered out since this implies the NLP engine 132 did not have sufficient detail to indicate a more specific concept. A second filtering technique for non-hierarchical concepts is used, wherein the results are filtered using a longest common subsequence algorithm and any candidates that do not have at least three common characters are filtered out. When multiple composite concepts are concluded after the filtering, all are returned as possible candidate concepts.

In an alternative embodiment to the above-described systems and methods, a Description Logic Reasoner can be used to directly infer the desired composite ontological concepts from the fragmented NLP results. The exemplary Description Logic Reasoner utilizes a set of known methods for making sound inferences from statements in description logic.

Those skilled in the art will understand that the above-described exemplary embodiments can be implemented in any number of manners, including, as a separate software module, as a combination of hardware and software, etc. For example, the system 100 and the related subsystems 110-140 may be a program containing lines of code stored on a non-transitory computer readable storage medium that, when compiled, may be executed on a processor. It should also be apparent from the above description that the exemplary embodiments allow the processing device to operate more efficiently when a user implements the system 100, e.g., by formatting the collected clinical information from patients, by encoding each imaging protocol using standardized terminology, by combining the encoded protocol data with the processed patient data to automatically recommend one or more imaging protocols, etc.

It is noted that the claims may include reference signs/numerals in accordance with PCT Rule 6.2(b). However, the present claims should not be considered to be limited to the exemplary embodiments corresponding to the reference signs/numerals.

It will be apparent to those skilled in the art that various modifications may be made in the present invention, without departing from the spirit or the scope of the invention. Thus, it is intended that the present invention cover modifications and variations of this invention provided they come within the scope of the appended claims and their equivalents.

1. A method, comprising:
collecting clinical information for a current patient;
generating an encoded description of a plurality of imaging protocols in a computer-processable format including medical concepts;
converting the collected clinical information into the computer-processable format; and
recommending or providing at least one suitable imaging protocol based on the encoded description and the converted clinical information for the current patient.

2. The method of claim 1, wherein converting the collected clinical information into the computer-processable format includes using at least one natural language processing (“NLP”) algorithm.

3. The method of claim 2, wherein the NLP algorithm identifies an encoded description of at least one medical concept within the collected clinical information.

4. The method of claim 2, wherein the NLP algorithm identifies portions of an encoded description of a medical concept within the collected clinical information.

5. The method of claim 4, wherein the portions of the encoded description are combined and further processed by the at least one NLP algorithm to identify encoded descriptions of at least one medical concept within the collected clinical information.

6. The method of claim 4, wherein a Description Logic Reasoner identifies at least one medical concept from the portions of the encoded description.

7. The method of claim 1, wherein the at least one suitable imagining protocol is recommended by a Description Logic Reasoner based on a set of clinical indication codes.

8. The method of claim 1, further comprising:
displaying the at least one suitable imaging protocol to a user over a user interface; and
receiving one of an acceptance instruction, a rejection instruction and a modification instruction from the user via the user interface.

9. The method of claim 1, further comprising:
recording a log of the clinical information and the at least one corresponding suitable imaging protocol, wherein the log includes the NLP algorithm and reasoning used by the NLP algorithm.

10. The method of claim 1, wherein the computer-processable format is one of a systematized nomenclature of medicine (“SNOMED”) format and a unified medical language system (“UMLS”) format.

11. The method according to claim 1, where the at least one suitable imaging protocol contains scanner settings which are transmitted to an imaging scanner to control the scanning operation of the imaging scanner.

12. A system, comprising:
a data collection subsystem for collecting clinical information for a current patient;
an imaging protocol subsystem for generating an encoded description of a plurality of imaging protocols in a computer-processable format including medical concepts;
a natural language processor for converting the collected clinical information into the computer-processable format; and
a protocol recommendation subsystem for recommending or providing at least one suitable imaging protocol based on the encoded description and the converted clinical information for the current patient.

13. (canceled)

14. (canceled)

15. (canceled)

16. (canceled)

17. The system of claim 12, further comprising:
a user interface displaying the at least one suitable imaging protocol to a user and receiving one of an acceptance instruction, a rejection instruction and a modification instruction from the user via the user interface.

18. (canceled)

19. The system according to claim 12, which further comprises a protocol transmission subsystem for transmitting scanner settings contained in the at least one suitable imaging protocol to an imaging scanner to control the scanning operation of the imaging scanner.

20. A non-transitory computer readable storage medium including a set of instructions that are executable by a processor, the set of instructions being operable at least to:
collect clinical information for a current patient;
generate an encoded description of a plurality of imaging protocols in a computer-processable format including medical concepts;
convert the collected clinical information into the computer-processable format;
recommend or provide at least one suitable imagining protocol based on the encoded description and the converted clinical information for the current patient.

21. (canceled)

22. (canceled)
